(19) United States
(12) Patent Application Publication
(10) Pub. No.: US 2011/0280484 A1
(43) Pub. Date: Nov. 17, 2011

(54) FEATURE DESIGN FOR HMM-BASED HANDWRITING RECOGNITION

(75) Inventors: Lei MA, Beijing (CN); Qiang HUO, Beijing (CN)

(73) Assignee: Microsoft Corporation, Redmond, WA (US)

(21) Appl. No.: 12/778,155

(22) Filed: May 12, 2010

(51) Int. Cl. G06K 9/18; G06K 9/00

(52) U.S. Cl. 382/185; 382/187

(57) ABSTRACT

The disclosed architecture is a new feature extraction approach to handwriting recognition. Given an handwriting sample (e.g., from an online source), a sequence of time-ordered dominant points are extracted, which include stroke-endings, points corresponding to local extrema of curvature, and points with a large distance to the chords formed by pairs of previously identified neighboring dominant points. At each dominant point, a multi-dimensional feature vector is extracted, which includes a combination of coordinate features, delta features, and double-delta features.

### BACKGROUND

Given the bandwidth capabilities of the Internet and increasing demands on such bandwidth due to multi-media content, improvements in recognition technologies are in demand for content such as speech, text, and more recently, languages. Many languages have characters that are relatively easily to recognize, except for the more complex characters associated with Asian languages such as Chinese, Japanese, and Korean, for example. Asian characters can include many cursive strokes, terminations, and crossings, all of which complicate the recognition process. Moreover, there are tens of thousands such characters that need to be recognized quickly with a high degree of accuracy.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a new feature extraction approach to handwriting recognition. Given an handwriting sample (e.g., from an online source), a sequence of time-ordered dominant points are extracted, which include stroke-endings, points corresponding to local extrema of curvature, and points with a large distance to the chords formed by pairs of previously identified neighboring dominant points. At each dominant point, a multi-dimensional feature vector is extracted, which includes a combination of coordinate features, delta features, and double-delta features.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates handwriting recognition system in accordance with the disclosed architecture.

FIG. 2 illustrates techniques for determining dominant points of character strokes.

FIG. 3 illustrates an example stroke over which feature extraction can be performed on dominant points.

FIG. 4 illustrates a computer-implemented handwriting recognition method in accordance with the disclosed architecture.

FIG. 5 illustrates further aspects of the method of FIG. 4.

FIG. 6 illustrates an alternative handwriting recognition method.

FIG. 7 illustrates additional aspects of the method of FIG. 6.

FIG. 8 illustrates a block diagram of a computing system that executes handwriting recognition in accordance with the disclosed architecture.

### DETAILED DESCRIPTION

The disclosed architecture is a new feature extraction approach to online Asian (e.g., Chinese, Japanese, Korean, etc.) handwriting recognition based on hidden Markov models (HMMs) (e.g., continuous-density HMM (CDHMM)). Given an online handwriting sample, preprocessing is performed to include normalization, removal of points, strokes can be removed, and dominant points identified for feature extraction.

More specifically in one implementation method, an Asian handwriting sample of multiple strokes is received after which the sample is normalized using linear mapping that preserves an aspect ratio of the sample. The normalized sample of strokes is converted into points and line segments. Redundant points in the converted sample are removed based on distance to a previous point. A stroke is removed based on distance between points and length of the stroke. The converted sample is analyzed for dominant points, and a sequence of feature vectors is then generated at the dominant points each of which includes coordinate features.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

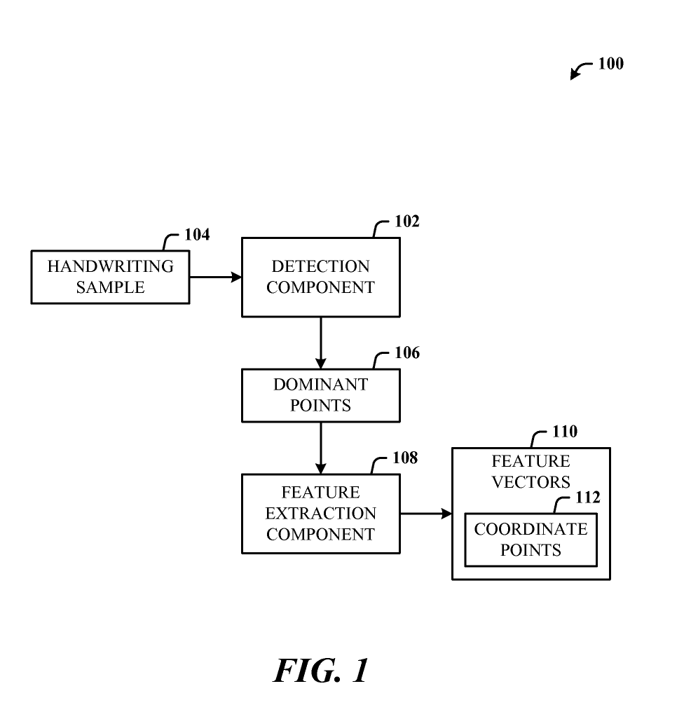

FIG. 1 illustrates handwriting recognition system 100 in accordance with the disclosed architecture. The system 100 includes a detection component 102 that receives a handwriting sample 104, analyzes the handwriting sample 104 for time-ordered dominant points 106, and outputs the dominant points 106. A feature extraction component 108 of the system 100 processes the dominant points 106 and generates feature vectors 110 for the dominant points 106. The feature vectors include coordinate features 112.

The handwriting sample 102 includes an Asian character such as of Chinese, Japanese, and/or Korean languages, for example. The dominant points 106 include stroke endings, and/or points associated with local extrema of curvature. The dominant points 106 can include points with a large distance to chords formed by pairs of previously identified neighboring dominant points. The feature vectors 110 include at least one of coordinate features, delta features, or acceleration features. The feature vectors 110 are multi-dimensional and further include at least one of delta features or acceleration features. Given the sequence of feature vectors extracted from the sample 104, each character class can be modeled by using a hidden Markov model (HMM).

Following are example feature vectors, F. For notational simplicity, (P₁, P₂, . . . , Pₜ, . . . , P_{T}) denotes the sequence of time-ordered dominant points extracted from an online handwriting sample, where Pₜ=(xₜ, yₜ) is the coordinates of the t-th dominant point. At each dominant point, the following four types of feature vector can be extracted:

F_{D}: 0ₜ=(Δxₜ, Δyₜ)^{T}^{ᵣ}, where Δxₜ=xₜ−xₜ₋₁ and Δyₜ=yₜ₋₁ are called “delta” features;

F_{DA}: 0ₜ=(Δxₜ, Δyₜ, Δ²xₜ, Δ²yₜ)^{T}^{ᵣ}, where Δ²xₜ=Δxₜ−Δxₜ₋₁ and Δ²yₜ=Δyₜ−Δyₜ₋₁ are called “double delta” or “acceleration” features;

F_{CD}: 0ₜ=(xₜ, yₜ, Δxₜ, Δyₜ)^{T}^{ᵣ}, where xₜ and yₜ are called “coordinate” features; and

F_{CDA}: 0ₜ=(xₜ, yₜ, Δxₜ, Δyₜ, Δ²xₜ, Δ²yₜ)^{T}^{ᵣ}.

For desktop and notebook computers, the 6-dimensional feature vector F_{CDA} gives improved recognition accuracy. For mobile and embedded devices, the 4-dimensional feature vector F_{CD} gives the best memory-accuracy tradeoff.

In one example implementation, preprocessing and feature extraction begins with a captured raw “ink” of an online handwritten character. The character is normalized to a 256×256 sample using an aspect-ratio preserving linear mapping. For each stroke, any point (except for ending points) which has a distance less than three to the previous point is treated as redundant and is removed accordingly. If the number of points in a stroke is less than three and the length of the stroke is less than fifteen, this stroke is treated as an artifact and is also removed.

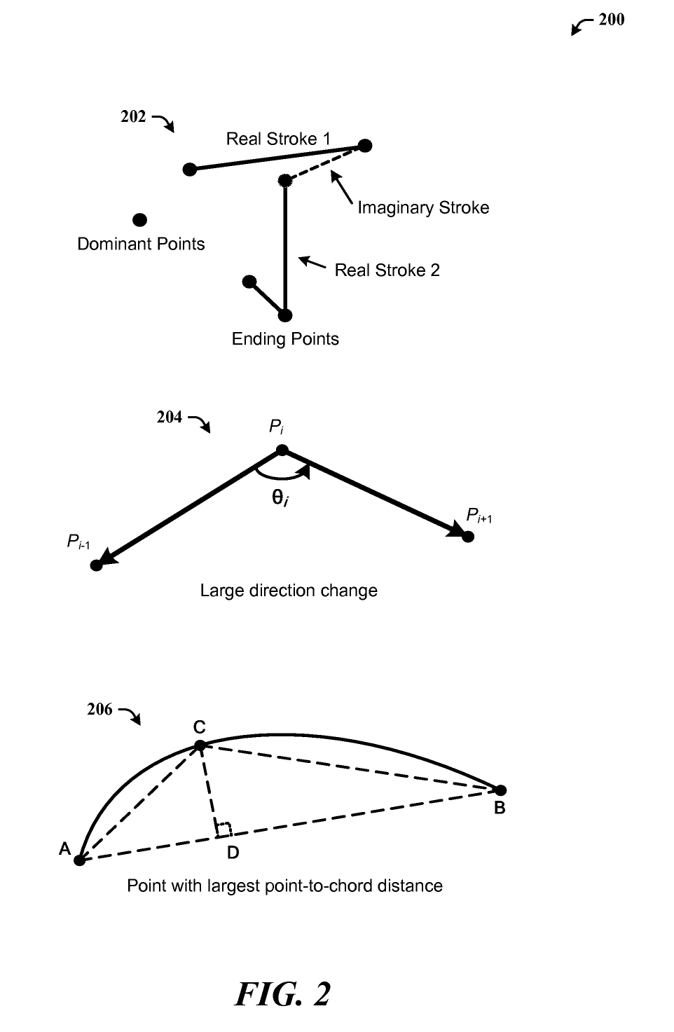

FIG. 2 illustrates techniques 200 for determining dominant points of character strokes. Given the processed “ink”, a procedure to detect a sequence of time-ordered dominant points includes analyzing stroke-endings 202, any point where the trajectory direction changes more than sixty degrees at 204, and any point which has the large enough maximum distance to the chord formed by the pair of previously identified neighboring dominant points at 206.

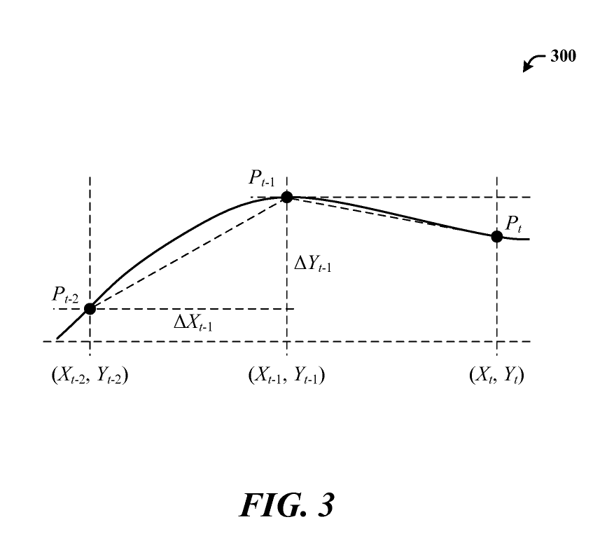

FIG. 3 illustrates an example stroke 300 over which feature extraction can be performed on dominant points. Heuristics can be used to obtain the refined set of dominant points above, (P₁, P₂, . . . , Pₜ, . . . , P_{T}), where Pₜ=(xₜ, yₜ) is the coordinates of the t-th dominant point. At each dominant point, a feature vector is extracted as follows:

0ₜ=(xₜ,yₜ,Δxₜ,Δyₜ)^{T}^{ᵣ}

where xₜ and yₜ are called “coordinate” features, and Δxₜ=xₜ−xₜ₋₁ and Δyₜ=yₜ−yₜ₋₁ are called “delta” features. Consequently, a sequence of T feature vectors 0=(0₁, 0₂, . . . , 0_{T}), can be extracted from a handwriting sample, where the first feature vector 0₁ is calculated specifically as 0₁=(x₁, y₂, 0,0)^{T}^{ᵣ}.

CDHMM can be used to model the whole character directly for simplicity. Assume that there are M character classes, Cᵢ, where i=1, 2, . . . , M, each is modeled by a left-to-right CDHMM allowing state transitions of skipping one state and having the mixture of Gaussians as probability density function (PDF) for each state as follows:

Pᵢₛ(0)=Σ^{K}^{ᵢₛ}ₖ₌₁ωᵢₛₖN(0;μᵢₛₖ,Σᵢₛₖ),

where ωᵢₛₖ, μᵢₛₖ and Σᵢₛₖ are the respective mixture weight, mean vector, and diagonal covariance matrix for the k^{th} component of state s in the i-th HMM. Let λᵢ denote the set of CDHMM parameters for class Cᵢ. The number of HMM states for λᵢ is set as the median value of the numbers of feature vectors per character sample calculated over the set of training samples for class Cᵢ.

In the recognition phase, an unknown character sample 0 is classified as class Cᵢ, if

$$i = arg {max}_{j} \{ {max}_{s} log p ( O , S \vert {λ}_{j} ) \}$$

where p(0, S|λⱼ) is the joint likelihood of the observation 0 and the associated hidden state sequence S given the HMM λⱼ, and

$${max}_{s} log p ( O , S \vert {λ}_{j} )$$

can be calculated efficiently by using a Viterbi algorithm.

With respect to classifier training, let [symbol] ={(0ᵣ, iᵣ)|r=1, . . . , R} denote the set of training samples, where 0ᵣ is the r-th training sample with Tᵣ feature vectors and iₜ denotes the index of its true class label. Given [symbol] , the set of CDHMM parameters, Λ={λᵢ|i=1, . . . , M}, is first estimated by using ML (maximum likelihood) training. Starting from well-trained ML models, Λ can be further refined by discriminative training. The following MMI (maximum mutual information) objective function is used:

$$f ( Λ ) = \frac{1}{R} {\sum }_{r = 1}^{R} log \frac{{p ( {O}_{r} \vert {λ}_{{i}_{r}} )}^{κ}}{{\sum }_{j = 1}^{M} {p ( {O}_{r} \vert {λ}_{j} )}^{κ}} ,$$

where κ is a control parameter set empirically by experimentation. The version of an extended Baum-Welch (EBW) algorithm is implemented to maximize the above objective function.

The set of parameters Λ can also be refined by minimizing the following MCE (minimum classification error) criterion:

$$l ( , ; Λ ) = \frac{1}{R} {\sum }_{r = 1}^{R} \frac{1}{1 + exp [ - α d ( {O}_{r} , {i}_{r} ; Λ ) + β ]} ,$$

where d(0ᵣ, iᵣ; Λ) is a misclassification measure defined as

$$d ( {O}_{r} , {i}_{r} ; Λ ) = \frac{1}{{T}_{r}} [ - log p ( {O}_{r} \vert {λ}_{{i}_{r}} ) + {max}_{i , i \neq {i}_{r}} log p ( {O}_{r} \vert {λ}_{i} ) ]$$

and α and β are two control parameters set empirically by experimentation. The objective function can be optimized by a sequential gradient descent algorithm (also referred to as generalized probabilistic descent (GPD)). However, to improve the throughput of experiments and take advantage of the computational capability offered by the accessible cluster computing infrastructure, in this implementation, the following batch mode gradient descent (GD) procedure is employed for MCE training:

Step 1: Run T_{GD} times of the following updating formula,

Λ_{τ+1}=Λ_{τ}−ε_{τ}^{GD}∇l( [symbol] , [symbol] ;Λ)|_{Λ=Λ}_{_{τ}}

where the learning rate evolves as

$${∈}_{τ}^{GD} = {∈}_{0}^{GD} ( 1 - \frac{τ}{{T}_{GD}} )$$

for τ=0, 1, . . . , T_{GA}−1. ε₀^{GD} is a control parameter that can be determined by experimentation.

Step 2: Repeat Step 1 T_{R}^{GD} times. Since the above procedure works in batch mode, it can be parallelized, for example, by using multiple computers to calculate the derivative in Step 1.

In addition to the above batch-mode GD approach, a batch-mode Quickprop algorithm can also be used for MCE training of HMM-based classifiers. The following modified Quickprop procedure is employed for MCE training of mean vectors of each Gaussian component:

Step 1: Let t=1. Calculate the derivative of l( [symbol] , [symbol] ; Λ) with respect to each μ_{iskd} and update the derivative by,

$${μ}_{iskd}^{( t + 1 )} = {μ}_{iskd}^{( t )} - {ɛ}_{0} \frac{\partial l ( , }{\partial {μ}_{iskd}} ,$$

where μ_{iskd} is the d-th element of μᵢₛₖ,

$$\frac{\partial l ( , }{\partial {μ}_{iskd}} {=}^{Δ} \frac{\partial l ( , }{\partial {μ}_{iskd}} \vert Λ = {Λ}^{( t )} ,$$

and ε₀ is an initial learning rate set empirically.

Step 2: Let t←t+1. Calculate the approximate second derivative of l(X, [symbol] ; Λ) with respect to each μ_{iskd} as follows:

$$\frac{{\partial }^{2} l ( , }{\partial {μ}_{iskd}^{2}} \approx \frac{\frac{\partial l ( , }{\partial {μ}_{iskd}} - \frac{\partial l ( , }{\partial {μ}_{iskd}}}{{μ}_{iskd}^{( t )} - {μ}_{iskd}^{( t - 1 )}} .$$

Step 3: Calculate the update step differently depending on the following cases:
If

$$\frac{{\partial }^{2} l ( , }{\partial {μ}_{iskd}^{2}} > 0$$

and the sign of gradient

$$\frac{\partial l ( , }{\partial {μ}_{iskd}}$$

differs from that of

$$\frac{\partial l ( , }{\partial {μ}_{iskd}} ,$$

then the following Newton step is used:

$${δ}_{t} {μ}_{iskd} = - \frac{\partial l ( , }{\partial {μ}_{iskd}} / \frac{{\partial }^{2} l ( , }{\partial {μ}_{iskd}^{2}} ,$$

where δₜμ_{iskd} denotes the update step of μ_{iskd}.
If

$$\frac{{\partial }^{2} l ( , }{\partial {μ}_{iskd}^{2}} > 0$$

and

$$\frac{\partial l ( , }{\partial {μ}_{iskd}} and \frac{\partial l ( , }{\partial {μ}_{iskd}}$$

have the same sign, the following modified Newton step is used:

$${δ}_{t} {μ}_{iskd} = - ( 1 / \frac{{\partial }^{2} l ( , }{\partial {μ}_{iskd}^{2}} + {ɛ}_{t} ) \frac{\partial l ( , }{\partial {μ}_{iskd}}$$

with εₜ being a learning rate set as

εₜ=ε₀(1−t/T_{Q}),

where T_{Q} is the total number of Quickprop iterations to be performed in one big cycle.
If

$$\frac{{\partial }^{2} l ( , }{\partial {μ}_{iskd}^{2}} < 0$$

or the magnitude of δₜμ_{iskd} is too small, backoff to gradient descent by setting the update step as follows:

$${δ}_{t} {μ}_{iskd} = - {ɛ}_{t} \frac{\partial l ( , }{\partial {μ}_{iskd}} .$$

Step 4: If |δₜμ_{iskd}|>limit×δₜ₋₁μ_{iskd}|, set

δₜμ_{iskd}=sign(δₜμ_{iskd})×limit×|δₜ₋₁μ_{iskd}|

to limit the absolute update step size, where limit is a control parameter and set as 1.75, for example.

Step 5: Update μ_{iskd} by

μ_{iskd}^{(t+1)}←μ_{iskd}^{(t)}+δₜμ_{iskd}.

Step 6: Repeat Step 2 to Step 5 T_{Q}−1 times.

Step 7: Repeat Step 1 to Step 6 T_{R}−1 times.

For simplicity, the formulas of relevant derivative calculation are omitted. Again, the above procedure can be easily parallelized by using multiple computers to calculate the derivative in Step 1.

With respect to compression of classifier parameters, in order to reduce footprint, CDHMM parameters can be compressed by using well-established techniques without incurring much degradation of recognition accuracy. Transition probabilities can be compressed aggressively using scalar quantization. Mean vectors and diagonal covariance matrices can be compressed by using a technique commonly known as subspace distribution clustering HMM (SDCHMM).

Rather than using Bhattacharyya distance to measure the dissimilarity between two Gaussians, the Kullback-Leibler (KL) divergence can be used because it is computationally more efficient, yet leads to recognizers with similar recognition accuracies. Subspace Gaussian clustering is conducted under the following two setups:
independently for each feature dimension (e.g., four streams), or
independently for two streams of subvectors defined as (xₜ, Δxₜ)^{T}^{ᵣ} and (yₜ, Δyₜ)^{T}^{ᵣ} respectively.

The Gaussian codebook size for each stream is 256. The set of mixture coefficients {ωᵢₛₖ} can be discarded in the recognition stage to save more memory space by evaluating the state likelihood pᵢₛ(0) approximately as follows:

$${p}_{is} ( 0 ) ≃ {max}_{1 \leq k \leq {K}_{is}} \frac{1}{{K}_{is}} 𝒩 ( O ; {μ}_{isk} , {\sum }_{isk}^{ } )$$

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

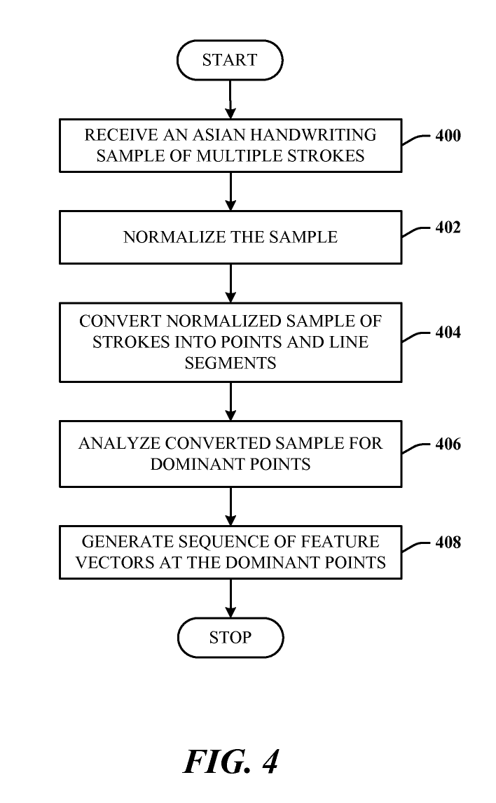

FIG. 4 illustrates a computer-implemented handwriting recognition method in accordance with the disclosed architecture. At 400, an Asian handwriting sample is received having multiple strokes. At 402, the sample is normalized. At 404, the normalized sample of strokes is converted into points and line segments. At 406, the converted sample is analyzed for dominant points. At 408, a sequence of feature vectors is generated at the dominant points.

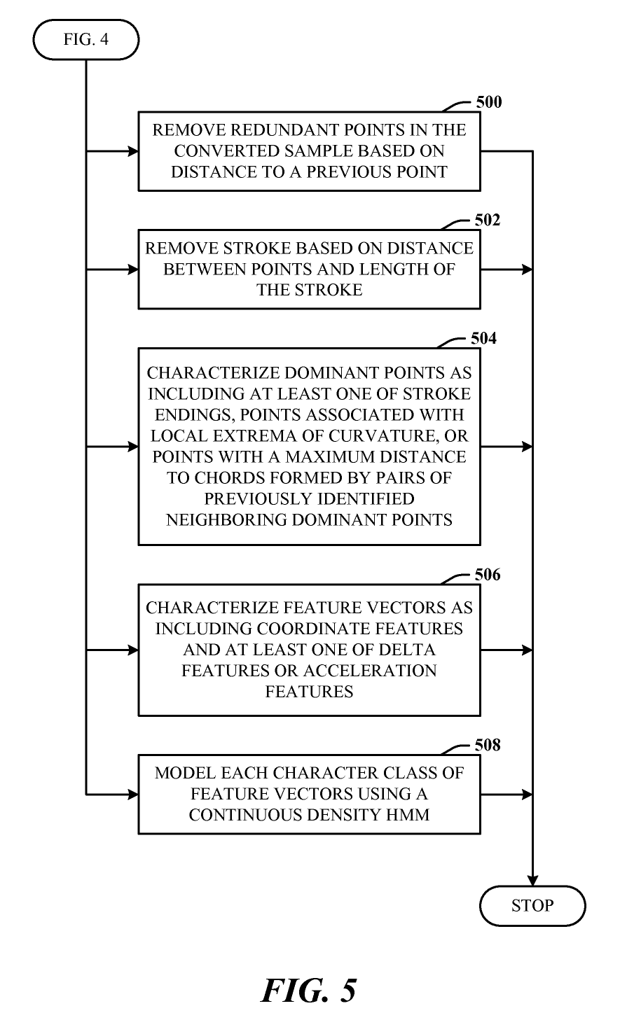

FIG. 5 illustrates further aspects of the method of FIG. 4. At 500, redundant points are removed in the converted sample based on distance to a previous point. At 502, a stroke is removed based on distance between points and length of the stroke. At 504, the dominant points are characterized as including at least one of stroke endings, points associated with local extrema of curvature, or points with a maximum distance to chords formed by pairs of previously identified neighboring dominant points. At 506, the feature vectors are characterized as including coordinate features and at least one of delta features or acceleration features. At 508, each character of the feature vectors is modeled using a continuous density HMM.

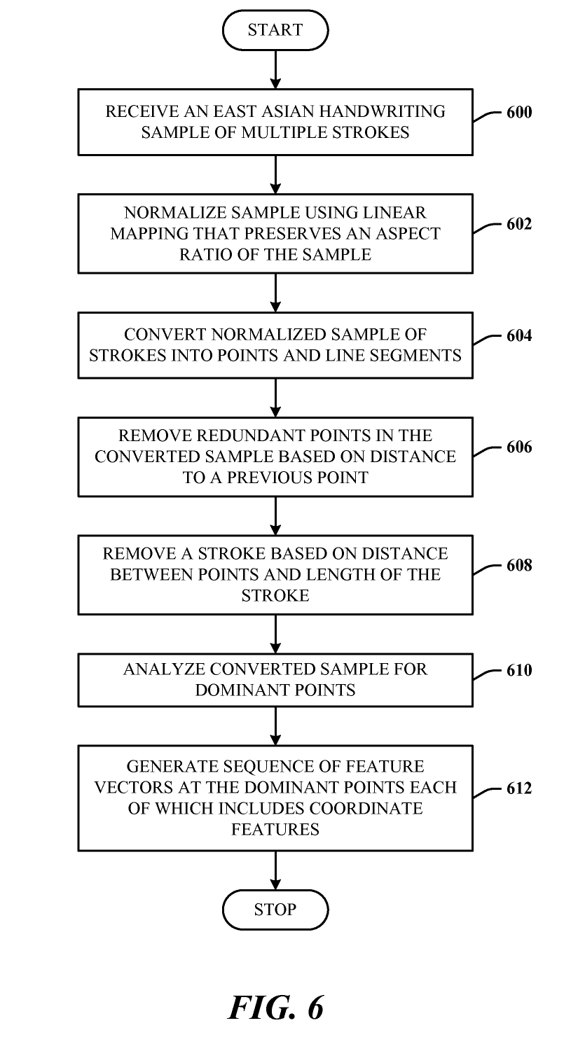

FIG. 6 illustrates an alternative handwriting recognition method. At 600, an East Asian handwriting sample of multiple strokes is received. At 602, the sample is normalized using linear mapping that preserves an aspect ratio of the sample. At 604, the normalized sample of strokes is converted into points and line segments. At 606, redundant points in the converted sample are removed based on distance to a previous point. At 608, a stroke is removed based on distance between points and length of the stroke. At 610, the converted sample is analyzed for dominant points. At 612, a sequence of feature vectors is generated at the dominant points each of which includes coordinate features.

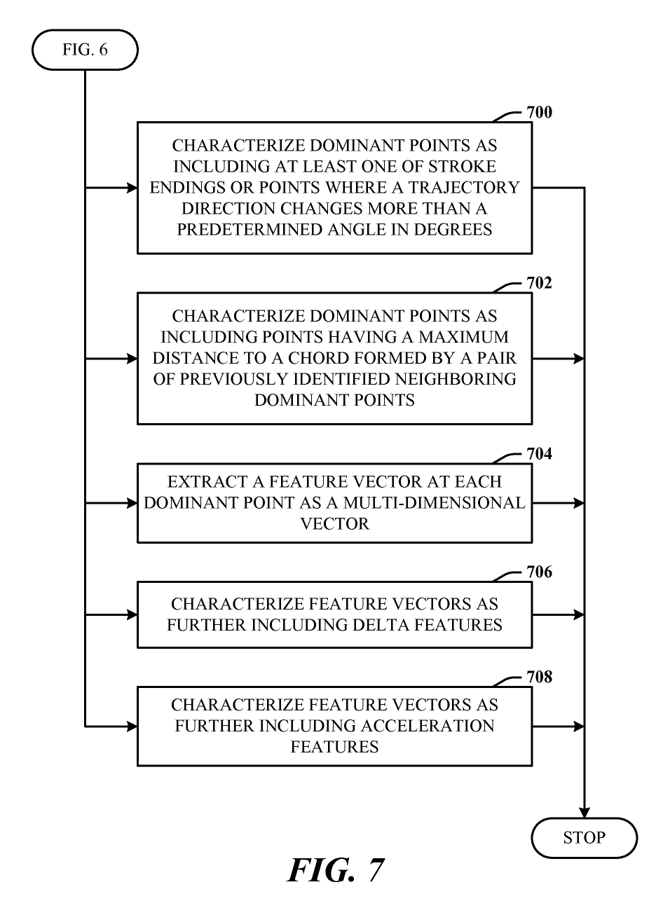

FIG. 7 illustrates additional aspects of the method of FIG. 6. At 700, the dominant points are characterized as including at least one of stroke endings or points where a trajectory direction changes more than a predetermined angle in degrees. At 702, the dominant points are characterized as including points having a maximum distance to a chord formed by a pair of previously identified neighboring dominant points. At 704, a feature vector is extracted at each dominant point as a multi-dimensional vector. At 706, the feature vectors are characterized as further including delta features. At 708, the feature vectors are characterized as further including acceleration features.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

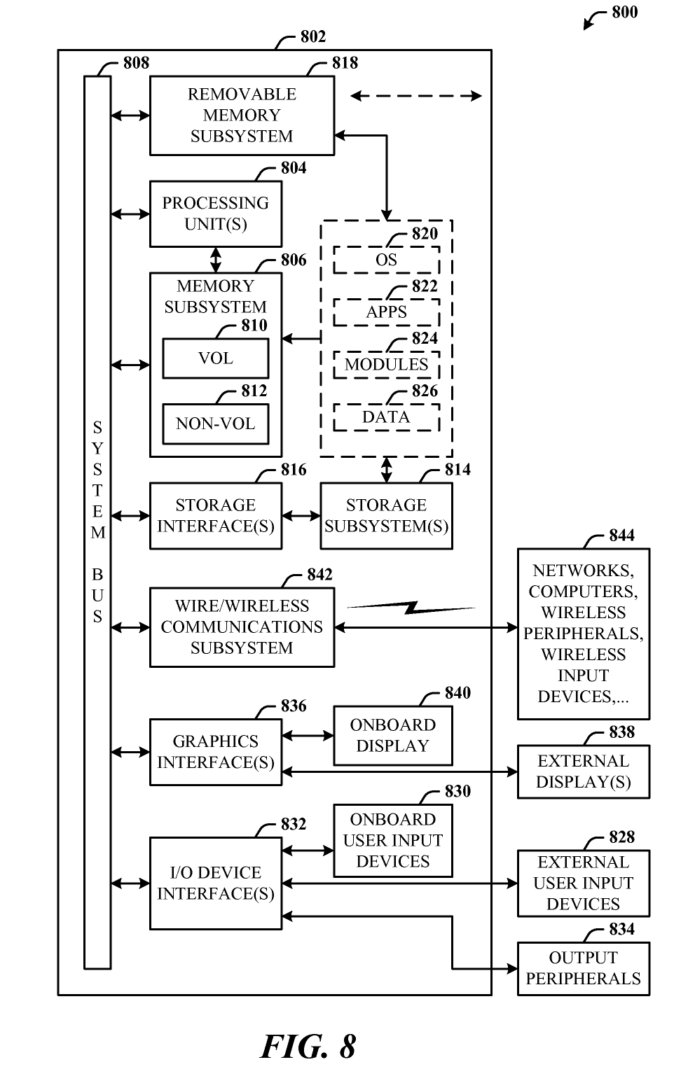

Referring now to FIG. 8, there is illustrated a block diagram of a computing system 800 that executes handwriting recognition in accordance with the disclosed architecture. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The one or more application programs 822, other program modules 824, and program data 826 can include the entities and components of the system 100 of FIG. 1, the techniques 200 of FIG. 2, the feature extraction over the dominant points of FIG. 3, and the methods represented by the flowcharts of FIGS. 4-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented handwriting recognition system having computer readable media that store executable instructions executed by a processor, comprising:
a detection component that receives a handwriting sample, analyzes the handwriting sample for time-ordered dominant points, and outputs the dominant points; and
a feature extraction component that processes the dominant points and generates feature vectors for the dominant points, the feature vectors include coordinate features.

2. The system of claim 1, wherein the handwriting sample includes an Asian character.

3. The system of claim 1, wherein the dominant points include stroke endings.

4. The system of claim 1, wherein the dominant points include points associated with local extrema of curvature.

5. The system of claim 1, wherein the dominant points include points with a large distance to chords formed by pairs of previously identified neighboring dominant points.

6. The system of claim 1, wherein the feature vectors include at least one of coordinate features, delta features, or acceleration features.

7. The system of claim 1, wherein the feature vectors are multi-dimensional and further include at least one of delta features or acceleration features.

8. The system of claim 1, wherein each character class of the feature vectors is modeled by using a hidden Markov model (HMM).

9. A computer-implemented handwriting recognition method executed via a processor, comprising:
receiving an Asian handwriting sample of multiple strokes;
normalizing the sample;
converting the normalized sample of strokes into points and line segments;
analyzing the converted sample for dominant points; and
generating a sequence of feature vectors at the dominant points.

10. The method of claim 9, further comprising modeling each character class of the feature vectors using a continuous density HMM.

11. The method of claim 9, further comprising removing redundant points in the converted sample based on distance to a previous point.

12. The method of claim 9, further comprising removing a stroke based on distance between points and length of the stroke.

13. The method of claim 9, further comprising characterizing the dominant points as including at least one of stroke endings, points associated with local extrema of curvature, or points with a maximum distance to chords formed by pairs of previously identified neighboring dominant points.

14. The method of claim 9, further comprising characterizing the feature vectors as including coordinate features and at least one of delta features or acceleration features.

15. A computer-implemented handwriting recognition method executed via a processor, comprising:
receiving an East Asian handwriting sample of multiple strokes;
normalizing the sample using linear mapping that preserves an aspect ratio of the sample;
converting the normalized sample of strokes into points and line segments;
removing redundant points in the converted sample based on distance to a previous point;
removing a stroke based on distance between points and length of the stroke;
analyzing the converted sample for dominant points; and
generating a sequence of feature vectors at the dominant points each of which includes coordinate features.

16. The method of claim 15, further comprising characterizing the dominant points as including at least one of stroke endings or points where a trajectory direction changes more than a predetermined angle in degrees.

17. The method of claim 15, further comprising characterizing the dominant points as including points having a maximum distance to a chord formed by a pair of previously identified neighboring dominant points.

18. The method of claim 15, further comprising extracting a feature vector at each dominant point as a multi-dimensional vector.

19. The method of claim 15, further comprising characterizing the feature vectors as further including delta features.

20. The method of claim 15, further comprising characterizing the feature vectors as further including acceleration features.
